(19) United States
(12) Patent Application Publication
(10) Pub. No.: US 2005/0108358 A1
(43) Pub. Date: May 19, 2005

(54) Web enabled peripheral device, method of using a web enabled peripheral device, and method of manufacturing and supporting a web enabled peripheral device

(76) Inventors: Daniel C. Jarvis, Eagle, ID (US); Ward S. Foster, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,660

(22) Filed: Nov. 3, 2003

(51) Int. Cl. G06F 15/16

(52) U.S. Cl. 709/217

(57) ABSTRACT

A web enabled peripheral device or internet appliance capable of executing services comprises means for maintaining, in the device, a list of services supported for use with the device; means for installing a service in response to the service being selected from the list by a user; and means for updating the list by communicating with a server external of the device, using which server a list of supported services can be updated for use by any of multiple said web enabled peripheral devices. Other methods and apparatus are also provided.

### FIELD OF THE INVENTION

The invention relates to embedded services or dynamically loadable embedded software for devices having processors. The invention also relates to embedded services for networked peripheral devices or web enabled appliances.

### BACKGROUND OF THE INVENTION

Many modern devices exist of the type having a processor and configured for network access, such as handheld devices, embedded devices, intelligent appliances, web enabled appliances, or networked peripheral devices like printers, scanners, or multi-function devices. Some of these devices are capable of running embedded “services,” which are dynamically loadable embedded software or “device applications.” A service can be any dynamically loadable software that can be executed by a device such as a networked peripheral device. Services are often written in the JAVA™ programming language. Devices that can run services typically also include embedded web servers that end users can use to adjust configuration parameters of the device.

Handheld devices, embedded devices, web enabled appliances, and networked peripheral devices, if capable of running services, will hereinafter be collectively referred to as web enabled peripheral devices. The term web enabled peripheral device is intended, however, to exclude personal computers such as desktop and laptop computers.

Examples of services include job tracking, job information, mobile printing (allowing print jobs to be sent through http), font conversion utilities, macros, and form creation utilities. This list is not intended to be exhaustive, but instead is to provide concrete examples of services.

The availability of the Java virtual machine (VM) and Internet accessibility to web enabled peripheral devices has enabled device developers to write Java applications for these devices.

An example of a product for loading services to a device from an Internet web server or some other network server is referred to as “Chai Loader.” It performs the task of loading objects to the printer from a URL. “Chai Loader” is included in “Chai Appliance Platform,” an integrated suite of embedded software products, development tools and services for web enabled peripheral devices, available from Hewlett-Packard Company, of Palo Alto, Calif., assignee of the present invention. Chai Loader is designed to download a package in its entirety to a device's memory, such as Flash Non-Volatile memory. Chai Loader also has the ability to download the content of a package to a RAM disk. The Chai Appliance Platform extends e-services from enterprise systems to web enabled peripheral devices. A component of the Chai Appliance Platform is the Chai Virtual Machine (ChaiVM), a small footprint, scalable environment for running Java applications on web enabled peripheral devices. ChaiVM substantially reduces the memory needed to support Java applications. By conserving memory, devices using this technology can be manufactured less expensively with strong functional and performance capabilities.

More and more services are being created by third party developers, as opposed to being created by manufacturers or authorized suppliers of the web enabled peripheral devices. As the number of available services increases, some services could be created that are not appropriate to be executed on all devices. For example, a service may not be designed for use with a particular model or type of device, or may require features not available on a particular model of device such as time services. For example, some printers have time services while some, typically older, printers do not have time services.

With this increase, it could become difficult for an owner or manager of a device to identify which services are appropriate or desired for a given device. Some ill-intending people could even create malicious services which an owner or manager (e.g., administrator) would not want on a device. Similarly, an owner or manager would not want poorly written services to be installed on their devices.

One known solution is to use embedded web servers. Embedded web servers are described in at least some of the below listed incorporated patents and patent applications. Some printers manufactured by the assignee of the present invention provide an HTML page called a loader which is used to start the process for installing (loading and starting) services. A disadvantage to this approach is that using these loader pages can be complicated. The HTML page is not linked into the pages that are accessible by just browsing to the printer. The user must know the specific URL of the loader in order to access this page. The loader page requires the user to type a complete URL to a JAR file containing the service to be installed. A JAR file is a Java archive that includes an executable file to allow downloading. This JAR file generally resides on a web server external to the printer thus requiring the user to provide and configure this other web server to serve up the JAR file.

Another known solution is to use a Web Jet Admin plug-in called Device Application Manager. Web Jet Admin and Device Application Manager are available from the assignee of the present invention. Web Jet Admin provides server based device management. Software running on a Web Jet Admin server discovers devices on a network and allows an administrator to configure the devices. The Device Application Manager has been created to allow a user to programmatically drive the loader page. This plug-in not only removes the user from the details of interacting with the loader page but also provides the ability to install (and otherwise manage) a service on multiple devices simultaneously. A disadvantage of this approach is that it requires the user to have and maintain another server on their network to run the WJA software. Customers may not want another server.

What is needed is an easier way for owners or administrators of web enabled peripheral devices to securely install specific services on their devices.

### SUMMARY OF THE INVENTION

Aspects of the invention provide a web enabled peripheral device or internet appliance capable of executing services. The device comprises means for maintaining, in the device, a list of services supported for use with the device; means for installing a service in response to the service being selected from the list by a user; and means for updating the list by communicating with a server external of the device, using which server a list of supported services can be updated for use by any of multiple said web enabled peripheral devices.

Other aspects of the invention provide methods of using a web enabled peripheral device capable of executing services, methods of manufacturing and supporting web enabled peripheral devices capable of executing services, and web enabled peripheral device systems.

In some aspects of the invention, users of the web enabled peripheral devices do not need to provide and update a server of their own to maintain a list of supported services.

These and other aspects of the present invention will be discussed in greater detail hereinafter.

### DESCRIPTION OF THE DRAWINGS

FIG. 1 is a block diagram of a system including web enabled peripheral devices, in accordance with various embodiments of the invention.

FIG. 2 is a screen shot of a web page showing a list of available services, in accordance with various embodiments of the invention.

FIG. 3 is a screen shot of an authentication request in accordance with various embodiments of the invention.

FIG. 4 is a flow chart of a method of manufacturing and supporting web enabled peripheral devices, in accordance with various embodiments of the invention.

### DETAILED DESCRIPTION OF THE INVENTION

This disclosure of the invention is submitted in furtherance to the constitutional purposes of the U.S. Patent Laws to promote the progress of science and the useful arts.

Devices that can run services and embedded web servers are described in U.S. patent application Publication No. 2002/0165784 to Taggart et al., assigned to the assignee of the present invention; U.S. patent application Publication No. 2002/0035636 to Gitsels et al.; U.S. patent application Publication No. 2002/0095425 to Abu-Husein, assigned to the assignee of the present invention; U.S. patent application Publication No. 2002/0035636 to Gitsels et al.; U.S. patent application Publication No. 2003/0135851 to Dickey et al., assigned to the assignee of the present invention; U.S. Pat. No. 6,170,007 to Venkatraman et al., assigned to the assignee of the present invention; and U.S. Pat. No. 6,493,517, also assigned to the assignee of the present invention, all of which are incorporated herein by reference. This is not meant to be an exhaustive list, but only a sampling. A review of these applications and patents will provide an understanding of services and web enabled peripherals.

The various figures show a web enabled peripheral device system 10. The system 10 includes a plurality of web enabled peripheral devices or networked appliances 12, and a server 14. The web enabled devices are configured to communicate with the server 14 via a network 16, such as the Internet, or via a LAN or WAN. Only one such web enabled device 12 is shown in detail, for simplicity.

The web enabled peripheral devices 12 can be handheld devices, embedded devices, web enabled appliances, or networked peripheral devices, if capable of running services. Each web enabled peripheral device 12 is capable of executing one or more services and includes a processor 18, and memory 20 coupled to the processor 18. This memory 20 can be RAM or other type of memory, a variety of types of memory, or multiple separate memories designated by a single block 20. The memory 20 is or includes, in some embodiments, non-volatile memory. A service is dynamically loadable software, as described above. A service 22 is shown loaded in memory 20. In some embodiments, some or all of the web enabled devices include Java virtual machines 23 or similar arrangements for executing the services 22.

Each web enabled peripheral device 12 is configured to store, in the memory 20, a list 24 of services 22 supported for use with the device 12. More particularly, in some embodiments, the devices 12 each include an embedded web server 26 configured to present one or more web pages including the lists of services. A web server is defined primarily by code, but also requires hardware such as the processor 18. Further, each web enabled device includes communications circuitry defining a network port so that the device can communicate with the server or other devices via the network. For example, the communications circuitry may be a network “card” or modem. In some embodiments, the processor 18 has integrated Ethernet. In some embodiments, a network port is included.

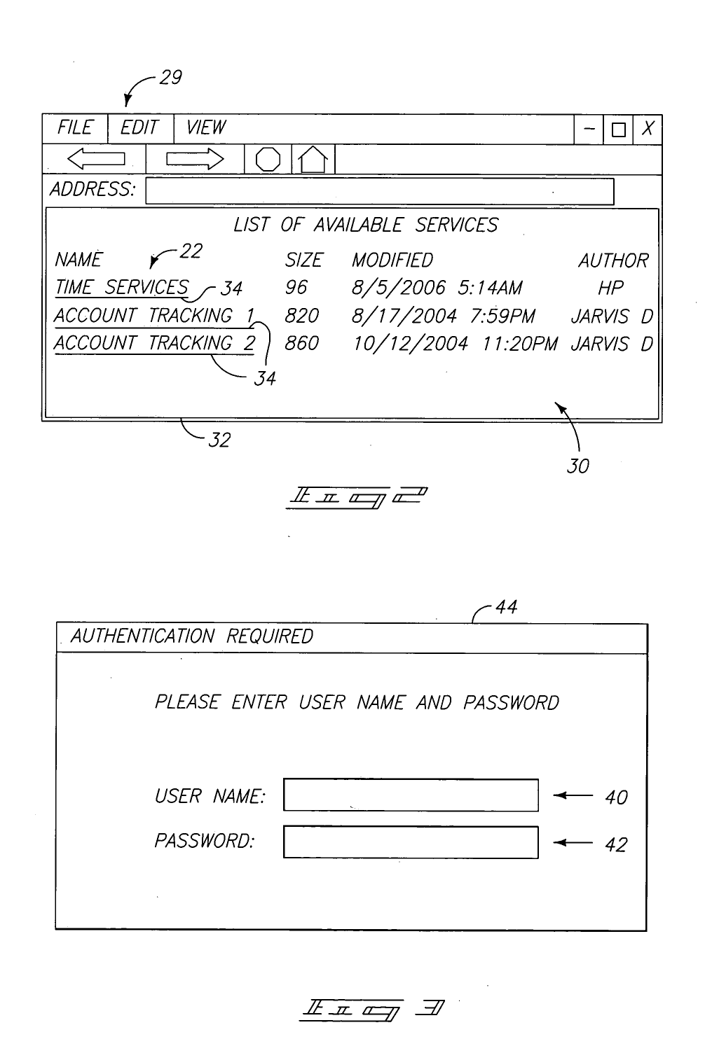

FIG. 2 illustrates a web browser 29. In the preferred embodiments, any type of Internet web browser could used to access the web server 26. In some embodiments (see FIG. 2), the devices 12 are each configured to present a list 30 of services on a web page 32 including hyperlinks 34, and to effect installation of a selected one of the services in response to one of the hyperlinks being selected.

The web enabled devices 12 are selectively configured to download and install, using the processor 18, a service 22, via the network 16 (e.g., the Internet), in response to the service 22 being selected from the list 30, for execution by the Java virtual machine 23. This involves downloading executable code from the server 14 and dynamically copying the code into memory 20.

In some embodiments, the web enabled peripheral devices 12 are of different types. For example, the web enabled devices 12 may include one or more printers 34, one or more scanners 36, one or more multi-function devices 38, and/or one or more intelligent domestic appliances 40 (e.g., web enabled refrigerators or security systems), some may be older, some may be newer, some may be laser printers, some may be inkjet printers, etc.

In some embodiments, the web enabled peripheral devices 12 each electronically store type-identifying data 39 such as make, model number and/or serial number, etc. This information 39 (or data representing this information) is selectively communicated by the web enabled peripheral devices 12 to the server 14 for use by the server 14 in updating the lists 30 of supported services maintained by the respective devices 12.

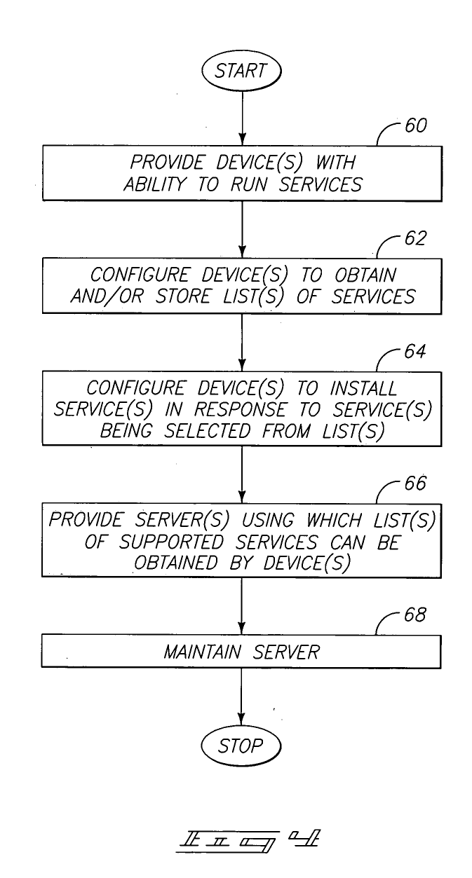

In some embodiments, the respective devices 12 comprise password authentication systems to restrict access to the respective lists 30 of services maintained in the devices. FIG. 3 illustrates an example of a password prompt screen 44 that the embedded server 26 could cause to be displayed to a user if the user attempts to browse (using web browser 29) to the web page 32 containing the list 30, by way of example only. Any desired text could be provided. For example, (see FIG. 3) a username 40 and password 42 may be required by the browser 29 (FIG. 2) before a web page 32 containing a list 30 of services can be reached. This allows an administrator (e.g., a computer network administrator of an organization or business that has multiple devices 12 or a parent of a household) to maintain control over services 22 that are installed and allows the administrator to prevent users from installing services.

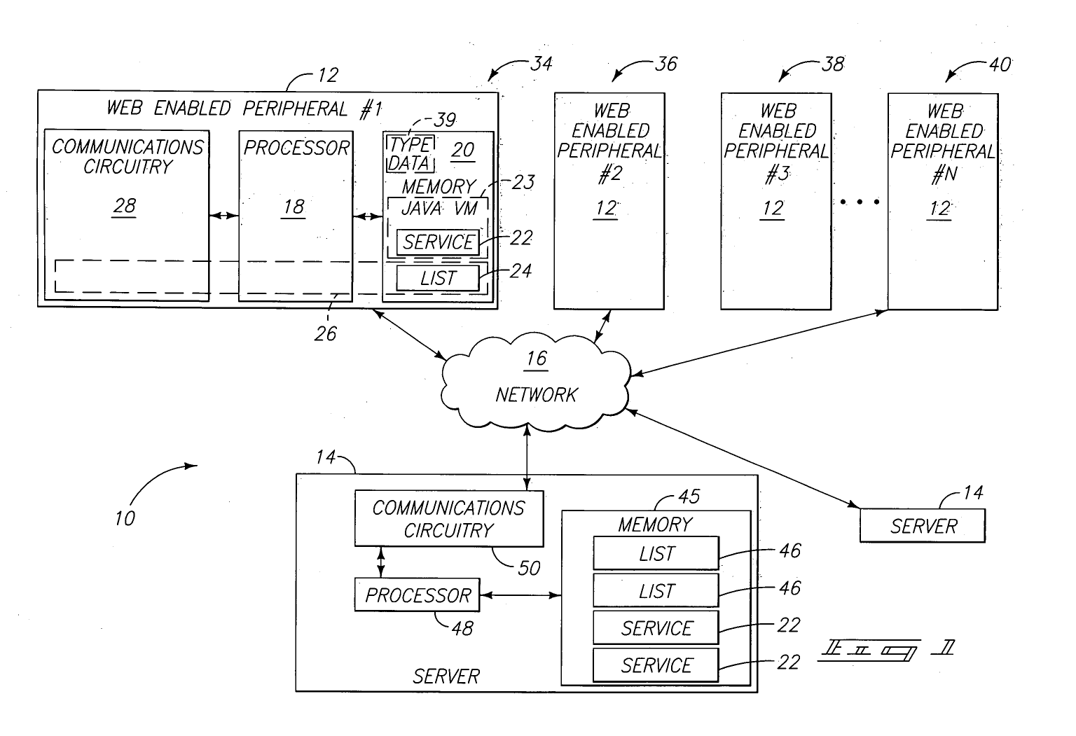

The server 14 shown in FIG. 1 is located external of the devices 12, and is controlled, for example, by the manufacturer of the devices 12, or by a distributor or vendor of the devices 12. The server 14 includes memory 45 configured to store lists 46 of supported services. The memory 45 can be defined by hard drives, optical drives, floppy drives, tape drives, RAM, ROM, or any other appropriate data storage device or devices. The server 14 further includes a processor 48 coupled to the memory 45. The server 14 further includes communications circuitry 50 so that it can communicate with the web enabled peripheral devices 12 or other devices (including other types of web enabled devices) via the network 16. For example, the communications circuitry 50 may be one or more network “cards” or modems or the server's processor 48 may have integrated ethernet. The server 14 is selectively contacted by devices 12 via the network 16.

The server 14 selectively communicates an updated list 30 (FIG. 2) of supported services 22 to any of the plurality of devices 12 in response to a request for an update from one of the web enabled peripheral devices 12 to the server 14. The requests for updates from any particular device 12 may be periodic, from time to time, manually requested, etc. In some embodiments, the request includes indicia (type data) 39 indicating a make, model number, serial number, or other information about the type of web enabled peripheral device 12 sufficient for the server 14 to be able to provide data representing a list 46 of services that are supported or appropriate for the particular type of device. In some embodiments, the server 14 has data representing lists 46 of supported services for each of multiple types of web enabled peripheral devices. The indicia 39 can be, for example, the make and/or model number and/or serial number (or serial number range) itself or a code indicating this information. The server 14 is configured to store data identifying supported services for each of the multiple models and/or serial numbers (or serial number ranges) of web enabled peripheral devices 12. More particularly, the server 14 is selectively updated with lists 46 of supported services for various types of web enabled devices 12. For example, a manufacturer's or vendor's representative will be responsible for updating the lists on the server 14. Thus, users of the web enabled peripheral devices 12 do not need to provide and update a server 14 of their own to maintain a list of supported services.

In some embodiments, the server 14 itself maintains copies of the services 22, and the devices 12 can download the services 22 from the server 14. In alternative embodiments, the server 14 points to or redirects to another or multiple other servers 14 when a device requests downloading of a selected service. In some embodiments, the listed services are or include Java services.

In some embodiments, the server 14 comprises a password authentication system to restrict access to the services that can be downloaded by the devices and to downloadable lists. For example, a username and password may be required by a web browser before web site administration pages can be reached allowing uploading of services or replacement or modification of data or files downloadable by the devices and using which the devices generate the lists of available services. A screen substantially similar to the one shown in FIG. 3 can be provided by the server 14. This allows an administrator (e.g., a manufacturer, distributor, or sales agent) to maintain control over services that are available for different types of devices.

In some embodiments, multiple servers 14 are provided for any of various reasons. For example, servers can be located in different geographic locations providing services tailored to users of a specific geographic location, whether by language, license terms, user acceptance of features, or for other reasons such as legal or marketing reasons. Alternatively, redundant servers 14 can be provided so that one server may be available to the devices if another server is down or too busy. Other reasons for providing multiple servers are possible.

Some aspects of the invention provide a method of manufacturing and supporting web enabled peripheral devices 12. This method is illustrated in FIG. 4.

In step 60, respective devices 12 are provided with the ability to run services. For example, in some embodiments, devices 12 are provided with Java virtual machines.

In step 62, the devices 12 are configured to selectively obtain and/or store a list 30 of supported (or approved, recommended or authorized) services 22. Lists 30 of services are maintained in respective devices 12.

In step 64, the respective devices are configured to install services in response to the services being selected from the lists, for execution by, for example, the Java virtual machines.

In step 66, a server 14 is provided, external of the devices (e.g., at a remote site). A list of supported services can be obtained by a web enabled peripheral device 12 using the server.

In step 68, the server 14 is maintained so that the list of supported services stored by each web enabled peripheral device 12 can be kept up to date. Thus, users of the web enabled peripheral devices 12 do not need to provide and update a server of their own to maintain a list of supported services.

Aspects of the invention provide various advantages. For example, in some embodiments:

A user does not need to learn, remember and enter a specific URL in order to access a loader page. The user just needs to browse to the web enabled peripheral device and follow the links to the page containing the list of supported services.

The user does not need to maintain a website external to the web enabled peripheral device in order to serve up installable services. The web enabled peripheral device uses a manufacturer's website (e.g., could be a website provided by the assignee of the present invention) or, if configured, a third party website.

The user does not need to enter the URL of an installable service. The user just selects the service from the list of supported services and selects it. The selection could take place in any of various ways known in the graphical user interface design arts for making selections; for example, a user can check a checkbox and click on an install button; a user can highlight a selection by tabbing or mousing over it then hitting the Enter key on a keyboard, or a user can click on a link identifying the service.

The user does not need to sort through all the available services for ones that are appropriate for a given device. A list contains only the services that are appropriate for the device.

The user does not need to worry about malicious or poorly written services. Only services that have passed necessary quality checks are put on the list.

For vertical markets, the manufacturer of the devices (e.g., the assignee of the present invention) or third parties can customize the list and website to provide only the sub-set of services that are appropriate for the market.

In compliance with the patent statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A web enabled peripheral device capable of executing services, the device comprising:
means for maintaining, in the device, a list of services supported for use with the device;
means for installing a service in response to the service being selected from the list by a user; and
means for updating the list by communicating with a server external of the device, using which server a list of supported services can be updated for use by any of multiple said web enabled peripheral devices.

2. A web enabled peripheral device in accordance with claim 1 and further comprising password authentication means for restricting access to the list of services maintained in the device, using which control can be maintained over which services are installed.

3. A web enabled peripheral device in accordance with claim 1 and further comprising authentication means for restricting access to the list of services, maintained in the external server, to persons other than the user.

4. A web enabled peripheral device in accordance with claim 1 and configured to execute Java services.

5. A web enabled peripheral device in accordance with claim 1 wherein the list is viewable using a web browser, wherein the list of services is presented to a web browser on a web page including hyperlinks, and wherein a service is installed in response to one of the hyperlinks being selected.

6. A web enabled peripheral device in accordance with claim 1 wherein the web enabled peripheral device defines a printer.

7. A web enabled peripheral device in accordance with claim 1 wherein the web enabled peripheral device defines a scanner.

8. A method of using a web enabled peripheral device capable of executing services, the method comprising:
maintaining, in the device, a list of services supported for use with the device;
installing a service in response to the service being selected from the list by a user; and
selectively updating the list by communicating with a server external of the device, using which server a list of supported services can be updated for use by the web enabled peripheral device.

9. A method in accordance with claim 8 and further comprising providing a server configured to be used in updating the list of supported services for the web enabled peripheral device.

10. A method in accordance with claim 8 and further comprising providing a server configured to be used in updating the list of supported services for the web enabled peripheral device, wherein the web enabled peripheral device has a model number, selectively communicated by the web enabled peripheral device to the server for use by the server in updating the list of supported services, and wherein the server has lists of supported services for each of multiple models of web enabled peripheral devices.

11. A method in accordance with claim 8 and further comprising restricting access to the list of services maintained in the device, wherein control can be maintained over which services are installed.

12. A method in accordance with claim 8 wherein the installed service is a Java service.

13. A method in accordance with claim 8 wherein the list is viewable using a web browser, the method further comprising presenting the list of services to a web browser on a web page including hyperlinks, and wherein the installation of the service occurs in response to one of the hyperlinks being selected.

14. A method of manufacturing and supporting web enabled peripheral devices capable of executing services, the method comprising:
providing respective devices with Java virtual machines;
configuring the respective devices to maintain lists of services supported for use with the devices;
configuring the respective devices to install the services in response to the services being selected from the lists, for execution by the Java virtual machines;
providing a server, external of the device, using which a list of supported services can be obtained by the web enabled peripheral device; and
updating the list on the server, wherein users of the web enabled peripheral devices do not need to provide and update a server of their own to maintain a list of supported services.

15. A method in accordance with claim 14 wherein the web enabled peripheral device is of a type selected from the group consisting essentially of printers, scanners and multi-function devices, and wherein the server has lists of supported services for each of multiple types of web enabled peripheral devices.

16. A method in accordance with claim 14 wherein the web enabled peripheral device has a model number, selectively communicated by the web enabled peripheral device to the server for use by the server in updating the lists of supported services maintained by the respective devices, and wherein the server has lists of supported services for each of multiple models of web enabled peripheral devices.

17. A method in accordance with claim 14 and further comprising restricting access to the list of services maintained in the device.

18. A-method in accordance with claim 14 wherein the installed service is a Java service.

19. A method in accordance with claim 14 wherein the list is viewable using a web browser, the method further comprising presenting the list of services on a web page including hyperlinks, and wherein the installation of the service occurs in response to one of the hyperlinks being selected.

20. A web enabled peripheral device system comprising:
a plurality of web enabled peripheral devices, each web enabled peripheral device having:
a Java virtual machine;
memory configured to maintain a list of services supported for use with the device; and
a processor configured to install a service, via the Internet, in response to the service being selected from the list, for execution by the Java virtual machine; and
a server, external of the devices, including memory configured to store lists of supported services, the server being selectively contacted by devices via the Internet, the server selectively communicating an updated list of supported services to any of the plurality of web enabled peripheral devices in response to a request for an update from one of the web enabled peripheral devices to the server, the request including indicia indicating a model of web enabled peripheral device, the server being selectively updated with lists of supported services for various models of web enabled devices, wherein users of the web enabled peripheral devices do not need to provide and update a server of their own to maintain a list of supported services.

21. A system in accordance with claim 20 wherein the web enabled peripheral devices are of different types selected from the group consisting essentially of printers, scanners and multi-function devices, and wherein the server has lists of supported services for each of multiple types of web enabled peripheral devices.

22. A system in accordance with claim 20 wherein the web enabled peripheral devices have respective model numbers, selectively communicated by the web enabled peripheral devices to the server for use by the server in updating the lists of supported services maintained by the respective devices, and wherein the server is configured to store data identifying supported services for each of multiple models of web enabled peripheral devices.

23. A system in accordance with claim 20 wherein the respective devices comprise password authentication systems to restrict access to the respective lists of services maintained in the devices.

24. A system in accordance with claim 20 wherein the lists of supported services include Java services.

25. A system in accordance with claim 20 wherein the lists are viewable by a web browser, wherein the web enabled peripheral devices are each configured to present the list of services on a web page including hyperlinks, and to effect installation of a selected one of the services in response to one of the hyperlinks being selected.

26. A system in accordance with claim 20 wherein the web enabled peripheral devices comprise printers.

27. A system in accordance with claim 20 wherein the web enabled peripheral devices comprise scanners.

28. A system in accordance with claim 20 wherein the web enabled peripheral devices comprise multi-function devices.

29. A system in accordance with claim 20 wherein the server comprises a password authentication system to control who is able to change the stored lists of supported services in the server.
